(19) United States
(12) Patent Application Publication
(10) Pub. No.: US 2007/0243128 A1
(43) Pub. Date: Oct. 18, 2007

(54) Process for producing hydrogen gas from sustainable biofuels or from other carbon based fuels

(75) Inventors: Benjamin Reichman, West Bloomfield, MI (US); William Mays, Commerce, MI (US); Michael A. Fetcenko, Rochester, MI (US); James Strebe, Clawson, MI (US)

Correspondence Address: ENERGY CONVERSION DEVICES, INC., 2956 WATERVIEW DRIVE, ROCHESTER HILLS, MI, 48309, US

(73) Assignee: Ovonic Battery Company, Inc.

(21) Appl. No.: 11/787,790

(22) Filed: Apr. 18, 2007

Related U.S. Application Data
(63) Continuation-in-part of application No. 10/763,616, filed on Jan. 23, 2004.
Application No. 10/763,616 is a continuation-in-part of application No. 10/636,093, filed on Aug. 7, 2003, now Pat. No. 6,994,839.
Application No. 10/763,616 is a continuation-in-part of application No. 10/321,935, filed on Dec. 17, 2002, now Pat. No. 6,890,419.
Application No. 10/763,616 is a continuation-in-part of application No. 09/929,940, filed on Aug. 15, 2001, now Pat. No. 6,607,707.

(51) Int. Cl. C01B 3/02

(52) U.S. Cl. 423/648.1

(57) ABSTRACT

A process for producing hydrogen gas is disclosed. In one embodiment, the process for produces hydrogen gas from biofuel reformation. The process includes the step of reacting a biofuel with a naturally occurring base.

### CROSS-REFERENCE TO RELATED APPLICATIONS

This applications is a continuation-in-part of application Ser. No. 10/763,616, entitled “Base-Facilitated Reformation Reactions of Organic Substances” which is a continuation in part of application Ser. No. 10/636,093 (U.S. Pat. No. 6,994,839), entitled “Carbonate Recycling in a Hydrogen Producing Reaction”, filed Aug. 7, 2003, of application Ser. No. 10/321,935 (U.S. Pat. No. 6,890,419), entitled “Electrolytic Production of Hydrogen”, filed Dec. 17, 2002, and of application Ser. No. 09/929,940 (U.S. Pat. No. 6,607,707), entitled “Production of Hydrogen From Hydrocarbons and Oxygenated Hydrocarbons”, filed Aug. 15, 2001, the disclosures of which are hereby incorporated by reference herein.

### BACKGROUND

In today's societies, conventional fossil fuels are primarily used to meet energy needs. As more societies modernize and existing modern societies expand, the consumption of energy continues to increase at ever growing rates. The increased worldwide use of fossil fuels is creating a number of problems. First, fossil fuels are a finite resource and concern is growing that fossil fuels will become fully depleted in the foreseeable future. Scarcity raises the possibility that escalating costs could destabilize economies. Second, fossil fuels are highly polluting. The greater combustion of fossil fuels has prompted recognition of global warming and the dangers it poses to the stability of the earth's ecosystem. In addition to greenhouse gases, the combustion of fossil fuels produces soot and other pollutants that are injurious to humans and animals. In order to prevent the increasingly deleterious effects of fossil fuels, new energy sources are needed.

The desired attributes of a new fuel or energy source include low cost, plentiful supply, renewability, safety, and environmental compatibility. Hydrogen is currently the best prospect for these desired attributes and offers the potential to greatly reduce our dependence on conventional fossil fuels. Hydrogen is the most ubiquitous element in the universe and, if realized, offers an inexhaustible fuel source to meet the increasing energy demands of the world. Hydrogen is available from a variety of sources including coal, natural gas, hydrocarbons in general, organic materials, inorganic hydrides and water. These sources are geographically well distributed around the world and accessible to most of the world's population without the need to import. In addition to being plentiful and widely available, hydrogen is also a clean fuel source. Combustion of hydrogen and electrochemical reactions utilizing hydrogen produce water as a by-product. Utilization of hydrogen as a fuel source thus avoids the unwanted generation of the carbon and nitrogen based greenhouse gases that are responsible for global warming as well as the unwanted production of soot and other carbon based pollutants in industrial manufacturing. Hydrogen truly is a green energy source.

The realization of hydrogen as a ubiquitous source of energy ultimately depends on its economic feasibility. Economically viable methods for producing hydrogen as well as efficient means for storing, transferring, and consuming hydrogen, are needed. Chemical and electrochemical methods have been proposed for the production of hydrogen. The most readily available chemical feedstocks for hydrogen are organic compounds, primarily hydrocarbons and oxygenated hydrocarbons. Common methods for obtaining hydrogen from hydrocarbons and oxygenated hydrocarbons are dehydrogenation reactions and oxidation reactions.

Steam reformation and the electrochemical generation of hydrogen from water through electrolysis are two common strategies currently used for producing hydrogen. Both strategies, however, suffer from drawbacks that limit their practical application and/or cost effectiveness. Steam reformation reactions are endothermic at room temperature and therefore require heating. Temperatures of a few to several hundred degrees are needed to realize acceptable reaction rates. These temperatures are costly to provide, impose special requirements on the materials used to construct the reactors, and limit the range of applications. Steam reformation reactions also occur in the gas phase, which means that hydrogen must be recovered from a mixture of gases through a separation process that adds cost and complexity to the reformation process. Steam reformation also leads to the production of the undesirable greenhouse gases CO₂ and/or CO as by-products. Water electrolysis has not been widely used in practice because high expenditures of electrical energy are required to affect water electrolysis. The water electrolysis reaction requires a high minimum voltage to initiate and an even higher voltage to achieve practical rates of hydrogen production. The high voltage leads to high electrical energy costs for the water electrolysis reaction and has inhibited its widespread use.

In U.S. Pat. Nos. 6,607,707 and 6,890,419, (the disclosures of which are incorporated by reference herein), the instant inventors considered the production of hydrogen from hydrocarbons and oxygenated hydrocarbons. In U.S. Pat. No. 6,607,707, the instant inventors considered the production of hydrogen through reactions of hydrocarbons and oxygenated hydrocarbons with a base. Using a thermodynamic analysis, the instant inventors determined that reactions of many hydrocarbons and oxygenated hydrocarbons react spontaneously with a base or basic aqueous solution to form hydrogen gas at particular reaction conditions, while the same hydrocarbons and oxygenated hydrocarbons react non-spontaneously in conventional steam reformation processes at the same reaction conditions. Inclusion of a base was thus shown to facilitate the formation of hydrogen from many hydrocarbons and oxygenated hydrocarbons and enabled the production of hydrogen at less extreme conditions than those normally encountered in steam reformation reactions.

Representative hydrogen producing reactions disclosed in U.S. Pat. No. 6,607,707 include the reactions of methanol in the presence of a base shown below:
CH₃OH+OH⁻+H₂O⇄3H₂+HCO₃⁻ (1)
CH₃OH+2OH⁻⇄3H₂+CO₃²⁻ (2)

As discussed in U.S. Pat. No. 6,607,707, both reactions may occur separately or simultaneously depending on the reaction conditions. The inventors showed that hydrogen was produced from a liquid phase mixture of methanol and a base and that hydrogen was the only gaseous product formed, thereby obviating the need for the gas phase separation required for conventional steam reformation processes. The required reaction temperature was less than the boiling point of the mixture and required only a modest input of energy. Analogous reactions with other hydrocarbons and oxygenated hydrocarbons were also disclosed.

U.S. Pat. No. 6,607,707 utilized potassium hydroxide as the base in the exemplary embodiment. Potassium hydroxide is a strong base which has a high solubility in level in water and therefore is highly reactive with the fuel component described in the '707 patent.

However, in certain applications it may be desirable to use other materials instead of or in combination with potassium hydroxide or sodium hydroxide. For example, sodium hydroxide and potassium hydroxide are not abundantly available in nature. Sodium hydroxide and potassium hydroxide are produced (along with chlorine and hydrogen) via the chloralkali process. This involves the electrolysis of an aqueous solution of sodium chloride. The electrolysis process consumes a large amount of electrical energy, thereby adding cost to the system for producing hydrogen gas. Further, additional steps must be taken to prevent the reaction of the NaOH with the chlorine. The sodium hydroxide builds up at the cathode, where water is reduced to hydrogen gas and hydroxide ion as shown below:
2Na⁺+2H₂O+2e⁻→H₂+2NaOH (3)
Since the reaction above requires high levels of electricity, power from power plants are utilized. Most power plants use combustion reactions that produce CO₂ as an energy producing byproduct. However, reactions that utilize naturally occurring bases do not require energy from power plant, and therefore will not produce CO₂ as a necessary byproduct.

In contrast to bases having a sodium cation and bases having a potassium cation, bases having a calcium cation are readily available in nature. For example, calcium oxide is abundantly available in the earth as quick lime and calcium hydroxide is abundantly available as hydrated lime. Further, adding water to calcium oxide will convert calcium oxide to calcium hydroxide.

Calcium compounds have previously been utilized as a reactant in a multistep recycling process for a hydrogen producing process. In U.S. Pat. No. 6,994,839 (the disclosure of which is incorporated by reference herein), the present inventors teach a recycling process which utilizes a carbonate metathesis reaction step in which sodium carbonate reacts with calcium hydroxide to form sodium hydroxide and calcium carbonate. The process is shown in the reactions (4-6) below:
Na₂CO_{3(aq)}+Ca(OH)_{2(aq)} [symbol] 2NaOH_{(aq)}+CaCO₃₍ₛ₎ (4)
CaCO₃₍ₛ₎+heat→CaO₍ₛ₎+CO_{2(g)} (5)
CaO₍ₛ₎+H₂O₍ₗ₎→Ca(OH)_{2(aq)} (6)

The process requires multiple steps and multiple different cations to accomplish the recycling process. Utilizing a cycling step that requires two or more different base cations adds complexity and cost to the recycling process. A recycling process utilizing only a calcium cation would reduce the cost and complexity of this process.

Ca(OH)₂ is benign, wherein KOH and NaOH will readily react with water in the atmosphere and can corrosively react with other materials. Therefore, using Ca(OH)₂ and or other benign substances as the base reactant in a hydrogen producing process can reduce the occurrence or the extent of undesired reactions, such as undesired corrosion reactions. This can allow a wider range of reactor building materials. Still further, substances having low solubility can allow easier and more efficient transportation and storage.

Therefore, processes which can utilize naturally occurring bases, low solubility reactants, and processes which can utilizing lower cost recycling methods are needed.

### SUMMARY

A process for producing hydrogen gas is disclosed. In one embodiment, the process for produces hydrogen gas from biofuel reformation. The process includes a step of reacting a biofuel with a naturally occurring base. A naturally occurring base can be any base that is readily available in the earth and does not require further conversion or refining besides the addition of water. In one embodiment, the naturally occurring base is CaO or Ca(OH)₂.

In one embodiment of the present disclosure, hydrogen gas is produced by a hydrogen producing reaction that utilizes a biofuel. A biofuel is any fuel source that is produced as a result of a biological process. In one embodiment, the biofuel is a renewable biofuel.

In one embodiment, the process for producing hydrogen gas includes the steps of reacting a biofuel with a naturally occurring base and recycling a byproduct of the step of reacting the biofuel with the naturally occurring base in a single step.

In one embodiment, the process for producing hydrogen gas includes the step of reacting a fuel component with a reaction mixture in the presence of a dissolution control agent to produce hydrogen gas. The fuel component comprises carbon. The reaction mixture comprises a solvent and a reaction component. The reaction component has a non solvated component and a solvated component, the non solvated component is in equilibrium with the solvated component.

### DETAILED DESCRIPTION

One aspect of the present disclosure is a process for producing hydrogen gas in the presence a dissolution control agent. In one embodiment, the hydrogen is produced from a sustainable biofuel. Sustainable biofuels as used herein refer to biofuels that meet present fuel needs without compromising the fuel needs of future generations. An example of a sustainable biofuel is a vegetation source that can be continually maintained and harvested. Hydrogen producing reactions that utilize sustainable biofuels have been described in previous applications (U.S. Pat. Nos. 6,607,707 and 6,890,419).

The hydrogen producing reactions generally involve the reaction of an organic substance with a base to produce hydrogen gas along with bicarbonate and/or carbonate ions as by-products. Representative reactions are described in the Background section hereinabove. The reactions occur in a liquid phase in which the base is at least partially soluble. Hydrogen gas is the only gas formed in the reaction and is recovered as it evolves from the liquid. The liquid phase may also include water and the base may be added in the form of an aqueous solution. The hydrogen producing reaction may be chemical or electrochemical in nature.

In one embodiment of the present disclosure, hydrogen gas is produced by a hydrogen producing process that utilizes a naturally occurring base. A naturally occurring base can be any base that is readily available in the earth and does not require further conversion or refining, besides the addition of water. In one embodiment, the naturally occurring base is abundantly available in the earth. In one embodiment, the naturally occurring base is CaO or Ca(OH)₂. In one embodiment, the naturally occurring base is MgO or Mg(OH)₂. In one embodiment of the present disclosure, hydrogen gas is produced by a hydrogen producing reaction that utilizes a biofuel. A biofuel is any fuel source that is produced as a result of a biological process. In one embodiment, the biofuel is a renewable biofuel.

In the present disclosure, the fuel component reacts with a reaction mixture to produce hydrogen gas in the presence of the dissolution control agent. The fuel component can includes a carbon containing fuel. The reaction mixture includes a solvent and a reaction component. The reaction component includes a non solvated component in equilibrium with a solvated component. Solvated component as used herein refers to any a component having its molecules surrounded by solvent molecules. In other words, attractive forces between solute molecules are not strong enough to hold multiple solute molecules in clusters. The non solvated component refers to a component having discrete clusters of molecules within the solvent. In other words, the solvated molecule is in a dissolved state and the unsolved molecules in an undissolved state. In water the solvated molecule can be said to be hydrated.

The dissolution control agent modifies the solubility level and/or the dissolution rate of the reaction component in the solvent. In one embodiment, the dissolution control agent is a physical substance. In one embodiment, the dissolution control agent is a process or a process condition.

The solubility level and the dissolution rate of the reaction component can affect the reaction between the fuel component and the reaction mixture. Therefore, substances having a high solubility level at standard atmospheric conditions where previously favored in hydrogen production processes. For example, substances having high solubility such as KOH and NaOH each have a solubility level of greater than 1 gram per milliliter at standard conditions and 25 degrees Celsius. Ca(OH)₂, however, only has a solubility level of 0.001 85 gram per milliliter at standard conditions and at 25 degrees Celsius.

The solubility of slightly ionic substances can also be described in terms of a solubility product (a Kₛₚ value). The Kₛₚ value is the product of the concentrations levels of ionic product species in the equilibrium reaction. Thus, a higher Kₛₚ indicates a higher solubility. The Kₛₚ values of selected metal hydroxides are shown in Table 1 below:

TABLE 1
Solubility-Product Constants (Kₛₚ) at 25 degrees Celsius

| | |
|---|---|
| Aluminum hydroxide Al(OH)₃ | 3 × 10⁻³⁴ |
| Calcium hydroxide Ca(OH)₂ | 6.5 × 10⁻⁶ |
| Cobalt (II) hydroxide Co(OH)₂ | 1.3 × 10⁻¹⁵ |
| Copper (II) hydroxide Cu(OH)₂ | 2.2 × 10⁻²⁰ |
| Iron (II) hydroxide Fe(OH)₂ | 4.1 × 10⁻¹⁵ |
| Iron (III) hydroxide Fe(OH)₃ | 1.6 × 10⁻³⁹ |
| Magnesium hydroxide Mg(OH)₂ | 6.3 × 10⁻¹⁰ |
| Magnesium (II) hydroxide Mg(OH)₂ | 1.6 × 10⁻¹³ |
| Nickel (II) hydroxide Ni(OH)₂ | 6 × 10⁻¹⁶ |
| Zinc hydroxide Zn(OH)₂ | 3 × 10⁻¹⁶ |

Although not wishing to be bound by theory, it is believed that in calcium hydroxide and in other substances having low Kₛₚ values (such as those listed in Table 1 above), OH⁻ ions are depleted in the hydrogen consumption reaction thereby resulting in poor reaction kinetics between the reaction mixture and the fuel component.

The present disclosure describes embodiments which utilize a dissolution control agent to control the dissolution of a reaction component. By controlling the dissolution of the reaction component, the dissolution control agent can control the reaction rate of the hydrogen producing processes. In one embodiment, the dissolution control agent controls a dissolution rate of the reaction component in the solvent. In another embodiment, the dissolution control agent controls a solubility level of the reaction component in the solvent. The dissolution control agent can control the reaction rate of the hydrogen producing process by, for example, increasing the hydrogen production rate, decreasing the hydrogen production rate, or stabilizing the hydrogen production rate.

In particular, in one embodiment, the dissolution control agent allows a low solubility reaction component to be utilized in a high-rate hydrogen production process. In another embodiment, the dissolution control agent allows a reaction rate between a reaction mixture and a fuel component to be modified without modifying the pH level of the reaction mixture.

In one embodiment, the dissolution control agent is a non solvated component of the reaction mixture having a controlled surface area. In particular, the non solvated component can have particles with a high surface area (that is, a high surface area-to-volume ratio or a high surface area-to-weight ratio.) The non solvated component particles having a high surface area can be classified according to their particles size. As used herein, the average diameter refers to the mean particle diameter of a population of particles. If a particle of the population of particles is irregularly shaped, the diameter can be determined by averaging the smallest diameter and the largest diameter of the particle.

In one embodiment, the average particle size of the non solvated component particles is less than 50 microns, more specifically, less than 20 microns, more specifically less than 10 microns, and still more specifically, less than 6 microns. In one embodiment, the average particle size of the non solvated component particles are greater 200 micrometers, more specifically, greater than 0.5 micrometers, and still more specifically, greater than 1 micrometer. In one embodiment, the non solvated component particles comprise nanoparticles and have an average particle size of less than 300 nanometers, and more specifically less than 150 nanometers, and still more specifically the particle size is about 100 nanometers. In one embodiment, the non solvated component particles comprise nanoparticles and have an average particle size of greater than 50 nanometers. In one embodiment, the non solvated component comprises a combination of nanoparticles and larger particles. The non solvated component particles can have a surface area of greater than 0.1 m²/g. In one embodiment, the non solvated component comprises nanoparticles having an average surface area of 50-300 m²/g.

In one embodiment, the non solvated component having a high surface area is contained in a micro-particulated hydrated slurry. In particular, the micro-particulated hydrated slurry is made by a process in which hydrated lime and water are blended to form a mixture. The mixture is agitated at high shear to form the slurry. The percent solids of the hydrated lime and water slurry are then adjusted to a predetermined percent weight of solids. In one embodiment, the weight solids is between 20 percent and 60 percent, more specifically, the weight solids is greater than 25 percent and still more specifically, the weight solids is greater than 35 percent. In various embodiments, the micro-particulated hydrated slurry can have different median particle sizes. For example, in one embodiment, the maximum median particle size is less than 20 microns, and in one embodiment, the average median particle size is less than 6 microns. In one embodiment, the minimum median particle size is greater than 0.5 microns, and in one embodiment, the minimum median particle size is greater than 2 microns. A description of methods of manufacturing micro-particulated slurries is contained in patent number U.S. Pat. No. 6,451,281 which is hereby incorporated by reference.

In one embodiment, the solid non solvated component can directly react with the fuel component. The dissolution control agent can increase a hydrogen production reaction rate between the fuel component and the non solvated component.

In one embodiment, the non solvated components having a high surface area are nanoparticles. Calcium hydroxide nanoparticles can be made, for example, by a homogenous phase synthesis method or by a slacked lime method. In the homogenous phase synthesis method, a solution containing calcium hydroxide nanoparticles is obtained by mixing NaOH solution with a CaCl₂ solution. Both solutions are heated to a selected temperature of about 90 degrees Celsius while continuously agitating the solutions. The resultant solution is supersaturated to 2 to 10 times saturation. Aqueous Ca(OH)₂ suspension is gradually cooled to room temperature under an inert gas atmosphere to avoid carbonation. The supernate solution is discarded and excess water is evaporated to obtain a desired Ca(OH)₂ concentration. In the slaked lime method, Calcium hydroxide microparticles are obtained by slacking CaO in water. These methods can produce nanoparticle Ca(OH)₂ dispersions having an average particle size of between 20 and 260 nanometers. In one embodiment, CaO nanoparticles are used.

In other embodiments, other methods can be utilized to produce micron sized and nanometer sized particles. These methods include mechanical or ultrasonic crushing methods, plasma spray methods, electrostatic deposition methods, thermal plasma methods, dc plasma jet, dc arc plasma and radio frequency (RF) induction plasmas methods.

Further, the non solvated particles can be classified to reduce the particle size or the particle size distribution. The classification method can include sieving the particles through a mesh or can include other classification methods.

Other non solvated components can be used instead of or in addition to Ca(OH)₂. For example, other calcium containing compounds and/or other base forming compounds. In one embodiment, an alkali metal hydroxide is used as the non solvated component. In one embodiment an alkaline earth metal hydroxide is used as the non solvated component. In one embodiment, a transition metal hydroxide is used.

In one embodiment, the dissolution control agent comprises an agent that chemically reacts to form the reaction component of the reaction mixture. In one embodiment, the dissolution control agent comprises an agent that chemically reacts to form the non solvated component of the reaction mixture. Although the dissolution control agent is described to form the non solvated component it is to be understood that the non-solvated component can then solvate immediately after forming.

In one embodiment the agent that chemically reacts to form the non solvated component is CaCl₂. The CaCl₂ is provided as an aqueous solution along with water and NaOH. NaOH reacts with the CaCl₂ to form Ca(OH)₂. In one embodiment, this reaction occurs at a temperature of 90 degrees Celsius. In one embodiment, a very small amount of NaOH is maintained in the solution so that the pH of the solution is not significantly increased by the NaOH. For example, the amount of NaOH in solution can be significantly low so that the pH of the solution is not raised above 13, more specifically 12.5, and still more specifically 12.

In other exemplary embodiments, other agents besides CaCl₂ can chemically react to form the non-solvated solution. In one embodiment, CaF₂ reacts to form the Ca(OH)₂ component. In one embodiment, CaO reacts to form the Ca(OH)₂ component. In one embodiment, an alkali metal salt reacts to form alkaline hydroxide molecules. In one embodiment, an alkaline earth metal salt reacts to form alkaline metal hydroxides. Other salts can be used as the agent that chemically reacts to form the non-solvated component. These other salts include transition metal salts, post-transition metal salts, lanthanide salts, and organic salts. In one embodiment, the dissolution control agent comprises a pH buffer.

In one embodiment, the dissolution control agent is an agitation process. The agitation can be any one or multiple types of agitations process that increase the dissolution rate of the non solvated particles. Exemplary agitation processes include stirring processes, vibrating processes, vortexing processes, milling processes (for example, attrition milling, ball milling, jet milling, and drying milling) and like processes.

In one embodiment, an impeller is rotated inside a mixing container so that the reaction mixture is agitated as the fuel component reacts with the solvated component.

In one embodiment, the agitation process is an ultrasonic agitation process. In the ultrasonic agitation process, alternating low-pressure and high-pressure waves are formed in the solvent, leading to the formation and violent collapse of small vacuum bubbles. This cavitation causes high speed impinging liquid jets and strong hydrodynamic shear-forces. The reaction mixture is agitated as the solvated compound. These effects result in the deagglomeration of particles, and an increase replenishment rate of solvated component ions that are consumed by reaction with the fuel component.

The above described agitation processes can increase the dissolution rate of the non solvated particles. The type of agitation and the rate of agitation can be selected based on a desired dissolution rate. Low energy agitation processes, such as low speed stirring, vibrating, vortex, and milling processes can increase the dissolution rate a factor of 100 to a factor of 1,000 over processes in which agitation is not used. High energy agitation processes such ultrasonic agitation processes, and high-speed vibrating, vortexing, and milling processes can increase the dissolution rate by a factor of greater than 1,000 over a process in which agitation is not utilized.

In one embodiment, the dissolution control agent is electromagnetic radiation. The dissolution control agent can include electromagnetic waves having a wide range of wavelengths within the electromagnetic radiation spectrum. Further, the dissolution control agent can include multiple electromagnetic waves having different wavelengths. In an exemplary embodiment, the dissolution control agent comprises microwave radiation.

The microwave radiation can increase the dissolution rate or the solubility level of the non solvated particle. In one embodiment, particles of the reaction absorb energy from the microwave radiation. When the molecules absorb the energy from the microwave radiation, dipoles of the molecules attempt to align themselves in an alternating electric field produced by the microwave radiation. The microwave radiation can then increase the dissolution rate or increase the solubility level by increasing kinetic energy or denaturing molecular bonds of molecules of the reaction mixture.

In one embodiment, the dissolution control agent is thermal energy. Thermal energy is utilized to increase the dissolution rate or the solubility level of the non solvated particle. It is recognized, that thermal energy is generally constantly present in any environment. Generally, the thermally energy of the dissolution control agent includes any energy that heats the system beyond that of normal atmospheric or room temperature conditions (for example, a thermal energy level that heats the solution above 25 degrees Celsius).

Thermal energy can be created through various exothermic processes and the thermal energy can be transferred through convection, conduction, or radiation. In one embodiment, thermal energy is utilized to raise the temperature of the reaction mixture to about 90 degrees Celsius to about 150 degrees Celsius, and more specifically about 100 degrees Celsius to about 140 degrees Celsius. In one embodiment, increasing the temperature raises the Ksp of the reaction mixture to above 1×10⁻⁴. In one embodiment, increasing the temperature of calcium hydroxide increases the Ksp from about 6.5×10⁻⁶ to above about 1×10⁻⁴.

In one embodiment, the dissolution control agent is a non aqueous solvent. The miscibility and the dispersibility of the non solvated particle are related to the polarity of the solution. In one embodiment, the non solvated particle has a relatively low polarity such that it does not readily disperse and dissolve in a polar, aqueous solvent. However, the non solvated particles will exhibit a higher degree of dispersion in certain solvents having a lower polarity than water. In one embodiment, the non solvated particle having relatively low polarity is Ca(OH)₂.

The non aqueous solvent can be one several types of solvents. In one embodiment, the non aqueous solvent is a hydrocarbon. The hydrocarbon can include an arene, an alkane, an alkene or an alkyne. Exemplary hydrocarbons include methane, ethane, propane, butane, pentane, hexane, heptane, octane, nonane, and decane. In particular, hydrocarbons that are liquid at room temperature such as pentane, hexane, heptane, and octane can be utilized. In one embodiment, the non aqueous solvent is an oxygenated hydrocarbon. In one embodiment, the non aqueous solvent is an alcohol. Exemplary alcohols include methanol, ethanol, propanol, isopropyl alcohol, butanol, and like alcohols. In one embodiment, the hydrocarbon is an aromatic hydrocarbon such as benzene, toluene and xylenes.

The amount of non aqueous solvent can be selected based on a desired solubility level or dispersion level of the reaction component. The reaction mixture solvent can comprise a small portion of non aqueous solvent or can comprise over 50% non aqueous solvent. Further, the fuel component can comprise the non aqueous solvent (that is, the non aqueous solvent can be consumed in the hydrogen producing reaction). In one embodiment, the fuel component is the non aqueous solvent and the fuel component comprises substantially all of the solvent of the reaction mixture. In one embodiment, the solvent of the reaction mixture comprises water and a non aqueous solvent, and the fuel component does not comprise the non aqueous solvent (that is, the non aqueous solvent is not consumed in the hydrogen producing reaction). In one embodiment, the solvent of the reaction component comprises above 90% non aqueous solvent.

In one embodiment, the dissolution control agent is a surfactant. The surfactant can be any substance capable of dispersing the reaction component by reducing the attractive forces between the reaction component particles. Since the particles remain dispersed, the particles maintain a high surface area and a high dissolution rate.

In one embodiment, the surfactant is a nonionic surfactant. In one embodiment, the surfactant is a silicon based surfactant. In one embodiment, the surfactant is a detergent.

In one embodiment, the dissolution control agent is a thickener. The thickener can be any substance utilized to increase the viscosity of the reaction mixture. Exemplary thickeners include polysaccharide based thickener (such as a starch or a gum), and protein based thickeners. In one embodiment, the thickener is an acrylic thickener. Exemplary acrylic thickeners include polyacrylic acid or polyacrylic acid salts. In one embodiment, the thickener is a cellulose based thickener. Exemplary cellulose based thickeners include hydroxypropyl methylcellulose thickeners (HPMC) and carboxy methyl cellulose (CMC).

The amount of thickener can be added to increase the viscosity of the reaction mixture a selected level. By increasing the viscosity of the reaction mixture, the thickener increases the duration that the non solvated component remains in suspension in the reaction mixture. In particular the amount of thickener can be added to increase the viscosity of the reaction mixture so that the mixture's viscosity is from 5×10⁻³ Pa·s to 50×10⁻³ Pa·s.

By using nano particles, thickeners, and/or surfactants as dissolution control agents, colloidal suspension can be formed in the reaction mixture. In one embodiment, an electrolytic process is used to charge the suspension to produce a colloid. In one embodiment a polymer coating material is used to provide the colloid. The non solvated particles can remain suspended in the reaction mixture for long periods of time, for example greater than a day or greater than 10 days.

The fuel component can be any component containing carbon. In one embodiment, the fuel component is a biofuel. In one embodiment, the fuel component includes a hydrocarbon or an oxygenated hydrocarbon. Exemplary hydrocarbons include alkanes, alkenes, alkynes and substituted forms thereof. Oxygenated hydrocarbon as defined herein refers to chemical compounds comprising carbon, hydrogen, and oxygen. Exemplary oxygenated hydrocarbons include alcohols, aldehydes, ketones, ethers, carboxylic acids and substituted forms thereof. In one embodiment, the fuel component comprises carbon monoxide. For exemplary processes in which carbon monoxide is utilized as a fuel component see U.S. patent application Ser. No. 11/079,610 which is herein incorporated by reference. In one embodiment, the fuel component comprises carbonaceous matter. For exemplary processes in which carbonaceous matter is utilized as a fuel component see U.S. patent application Ser. No. 10/984,202 which is herein incorporated by reference. In one embodiment, the fuel component comprises biomass. For exemplary processes in which biomass is utilized as a fuel component see U.S. patent application Ser. No. 10/966,001 which is herein incorporated by reference. In one embodiment, the fuel component comprises a non-cyclic organic substance having multiple alcohol functionality. For exemplary processes in which a non-cyclic organic substance is utilized as a fuel component see U.S. patent application Ser. No. 10/966,001 which is herein incorporated by reference.

The solvent is provided as a medium in which the reaction component can dissociate to form a solution that can react with the fuel component to produce hydrogen. In one embodiment the solvent is water. In another embodiment, the solvent includes a hydrocarbon or an oxygenated hydrocarbon. In another embodiment, the solvent includes both water and a hydrocarbon or oxygenated hydrocarbon. In another embodiment, the solvent includes a fuel component (that is, the reaction component dissociates in the fuel component). In another embodiment, the solvent includes mixture having a fuel component and a component that is not a fuel component.

The reaction component can be any number of different substances having an hydroxide (OH) group that are capable of reacting with fuel component to produce hydrogen. The reaction component has both a solvated component and a non solvated component. In one embodiment, the reaction component forms a basic solution in the solvent. Exemplary reaction components include hydrogen peroxide, metal hydroxides (for example Ca(OH)₂, KOH, NaOH, etc.) and non-metal hydroxides (for example, ammonium hydroxide.) Exemplary bases include, but are not limited to, alkali metal hydroxides, alkaline earth metal hydroxides, transition metal hydroxides, post-transition metal hydroxides, lanthanide hydroxides, and organic hydroxides.

The ratio of reaction component to solvent can be selected to provide a selected hydrogen production reaction rate. In one embodiment, the reaction component comprises at least 15 weight % of the reaction mixture. In one embodiment, the reaction component comprises at least 25 weight % of the reaction mixture.

In one embodiment, during the hydrogen producing reaction, metal carbonates are formed as bi-products as shown in reaction I below:
organic substance+metal hydroxide→hydrogen gas+metal carbonate (I)

The hydrogen producing reaction can further include a recycling step. In one embodiment, the recycling step comprises thermally decomposing a metal carbonate precipitate to produce a metal oxide.

In U.S. Pat. No. 6,994,839, the present inventors teach a recycling process which utilizes a carbonate metathesis reaction step in which sodium carbonate reacts with calcium hydroxide to form sodium hydroxide and calcium carbonate. The calcium carbonate solid is then separated from the solution phase and the solution, and is thermally decomposed to form calcium oxide and carbon dioxide. In a third step, the calcium oxide is reacted with water to form calcium hydroxide.

The present disclosure teaches a recycling process without a carbonate metathesis reaction step. Instead, in the present disclosure the reaction component forms a metal carbonate as a product of the hydrogen producing reaction. The metal carbonate precipitate is separated by from the solvent by a separation step such as filtering or evaporating the solvent. The recycling reactions for a hydrogen producing reaction utilizing a Ca(OH)₂ reaction component and a CH₃OH fuel are shown in reactions II-IV below:
Ca(OH)_{2(aq)}+CH3OH₍ₗ₎→CaCO₃₍ₛ₎+H_{2(g)} (II)
CaCO₃₍ₛ₎+heat→CaO₍ₛ₎+CO_{2(g)} (III)
CaO₍ₛ₎+H₂O₍ₗ₎→Ca(OH)_{2(aq)} (IV)

Instead of discarding the calcium carbonate byproduct as a waste product, the recycling process can regenerate the calcium carbonate ion by converting the calcium carbonate to useable Ca(OH)₂ in a recycle process.

The use of hydrogen producing process that reacts Ca(OH)₂ with a biofuel to form hydrogen and CaCO₃ allows for an efficient recycling mechanism. Since the process produces non soluble CaCO₃ as a byproduct, the process is much easier to recycle than previous processes. Wherein previous reactions require a step of converting the byproduct of the hydrogen producing reaction to CaCO₃, CaCO₃ is already available as a product in the present embodiment. Therefore, CaCO₃ can be rejuvenated to CaO in a single reaction step, that is, CaCO₃ is heated and decomposes to CaO and CO₂.

In one embodiment, the dissolution control agent is present during the recycling step. In one embodiment, the dissolution control agent is a dissolution rate control agent and is present during the recycling process. In one embodiment, the affect of the dissolution control agent is reduced during the recycling process. In one embodiment, the dissolution control agent is a solubility level control agent that has been removed or whose affect has been decreased during the recycling process.

In one embodiment, the dissolution control agent comprises an agitation process. The reaction mixture is agitated during the step of reacting the fuel component with the reaction mixture to produce hydrogen gas. The agitation level is reduced during recycling step.

The metal cation of the hydrogen production reaction can be selected to produce a desired recycling component. Precipitation is promoted through the use of a metal hydroxide reactant whose metal cation has a low carbonate Kₛₚ value. The Kₛₚ values of several weakly soluble or insoluble metal carbonates are included in Table 1 below:

TABLE 2
Solubility Product Constant (Kₛₚ) Values of Representative
Metal Carbonates at 25° C.

| Compound | Kₛₚ |
|---|---|
| CaCO₃ | 3.3 × 10⁻⁹ |
| BaCO₃ | 2.0 × 10⁻⁹ |
| CdCO₃ | 1.8 × 10⁻¹⁴ |
| CoCO₃ | 1.0 × 10⁻¹⁰ |
| CuCO₃ | 3 × 10⁻¹² |
| PbCO₃ | 7.4 × 10⁻¹⁴ |
| MgCO₃ | 3.5 × 10⁻⁸ |
| NiCO₃ | 1.3 × 10⁻⁷ |
| SrCO₃ | 5.4 × 10⁻¹⁰ |
| ZnCO₃ | 1.0 × 10⁻¹⁰ |
| FeCO₃ | 3.5 × 10⁻¹¹ |

Use of a metal hydroxide reactant that includes a cation from represented in the carbonates of Table 2, promotes the formation of a carbonate precipitate in the hydrogen production reaction. In the foregoing example, calcium hydroxide was used as the metal hydroxide reactant in the hydrogen production reaction. Therefore, the product of the hydrogen production reaction is weakly soluble calcium carbonate (Kₛₚ=3.3×10⁻⁹). The selection of calcium hydroxide as a reactant thus permitted the formation of a weakly soluble metal carbonate. Through consideration of Kₛₚ, other suitable metal hydroxide reactants may be similarly identified to promote the formation of weakly soluble or insoluble metal carbonate products. Use of barium hydroxide (Ba(OH)₂), for example, as the metal hydroxide reactant in the hydrogen production reaction leads to formation of weakly soluble and hence readily precipitatable BaCO₃. Preferably, the Kₛₚ value of the metal carbonate bi-product of the hydrogen production reaction is less than 10⁻⁶.

The precipitated metal carbonate product of the hydrogen production reation is decomposed in a thermal decomposition step (e.g. equation IV in the foregoing example) to form a metal oxide and carbon dioxide gas. Carbonate thermal decomposition is a well-known reaction and essentially all metal carbonates undergo decomposition. Thermal decomposition of metal carbonates can be depicted generally by the following reaction:
MCO₃₍ₛ₎+heat→MO₍ₛ₎+CO_{2(g)} (V)
The above reaction is written for a divalent metal (M²⁺). Analogous reactions can be written for carbonates of metals that are monovalent, trivalent etc.

The metal oxide formed in the decomposition step is subsequently reacted with water to form a hydroxide (e.g. step 3 in the foregoing example). The general reaction for this step can be written:
MO₍ₛ₎+H₂O₍ₗ₎→M(OH)_{2(aq)} (VI)
The above reaction is written for a divalent metal (M²⁺). Analogous reactions can be written for carbonates of metals that are monovalent, trivalent etc.

In one embodiment of the hydrogen producing processes above, pH can be controlled such that the reaction mixture will not be highly corrosive. In one embodiment, the pH is less than 13. In one embodiment, the pH is less than 12.5. In one embodiment, the pH is less than 12. In one embodiment, the pH of the reaction mixture is greater than 7. In one embodiment of hydrogen producing process, the pH of the reaction mixture is controlled such that the reaction mixture is highly corrosive so that the reaction mixture can more effectively react with the fuel. In one embodiment, the pH of the reaction mixture is higher than 13.

In one embodiment, the pH of the reaction mixture remains at a constant level during the hydrogen producing process. In one embodiment, the pH of the reaction mixture varies less than 1, more specifically less than 0.5, and still more specifically less than 0.1. In on embodiment, the lack in variation in the pH value is due to the rapid replenishment of OH⁻ ions during the hydrogen production process.

In one embodiment, the pH of the reaction mixture is elevated during the hydrogen production reaction, but the pH of the reaction mixture decreases when hydrogen production is not taking place. In other words, the reaction mixture has two operational states: a reaction state and a hibernation state. When the reaction mixture is in the reaction state, the dissolution control agent raises the pH of the reaction mixture. When the reaction mixture is in the hibernation state, the pH of the reaction mixture is lower then when the reaction mixture is in the reaction state.

The reaction control agent can include multiple physical agents, multiple processes or process components, or combinations of physical agents and process components. For example in one embodiment, the reaction control agent comprises both a non solvated particle with a controlled surface area and thermal energy. In one embodiment, the reaction control agent comprises both a dispersant and an agitation process. In one embodiment, the reaction control agent comprises a non solvated particle with a low surface area, an agitation process and thermal energy.

The specific dissolution control agent or the specific attribute of the dissolution control agent described above can be selected so that a desired dissolution rate or a desired solubility level can be achieved. In one embodiment, the dissolution control agent can increase the dissolution rate of the reaction component a factor of 100 to a factor 1,000 over a process in which the dissolution control agent is not used. In one embodiment, the dissolution control agent can increase the dissolution rate of the reaction component by greater a factor of 1,000 over a process in which the dissolution control agent is not used.

In one embodiment, the dissolution control agent can increase the solubility level of the reaction component by a factor of 10 to a factor of 100 over a process in which the dissolution control agent is not used. In one embodiment, the dissolution control agent can increase the solubility level of the reaction component by a factor of greater than 100 over a process in which the dissolution control agent is not used.

As mentioned previously, the present invention is thought to work in several different systems. Although several embodiment, discuss the benefits of using Ca(OH)2, it is thought that the practice of the invention can also be applied to other systems utilizing other reaction components. For example, the embodiments in the present disclosure can be adapted for use with other components such as LiOH. LiOH can also have several advantages over current systems in that LiOH is a very light substance, and therefore, desired hydrogen production rates can be achieved in LiOH system, while utilizing a lower weight of reaction component that in other systems.

It should be understood that the present invention is not limited to the precise structure of the illustrated embodiments. The disclosure and discussion set forth herein is illustrative and not intended to limit the practice of the instant invention. While there have been described what are believed to be the illustrative embodiments of the instant invention, those skilled in the art will recognize that other and further changes and modifications may be made thereto without departing from the spirit of the invention, and it is intended to claim all such changes and modifications that fall within the full scope of the invention. It is the following claims, including all equivalents, in combination with the foregoing disclosure and knowledge commonly available to persons of skill in the art, which define the scope of the instant invention.

1. A process for producing hydrogen gas from biofuel reformation including the step of:
reacting a fuel comprising carbon with a naturally occurring base.

2. The process of claim 1, wherein the naturally occurring base is Ca(OH)₂, CaO, Mg(OH)₂, or MgO

3. The process of claim 2, wherein the naturally occurring base comprises Ca(OH)₂ particles having a particle size of less than 20 microns.

4. The process of claim 1, wherein the fuel comprising carbon is a renewable biofuel.

5. The process of claim 1, wherein the fuel comprising carbon is an alcohol.

6. A process for producing hydrogen gas from biofuel reformation including the steps of:
reacting a fuel comprising carbon with a naturally occurring base and
recycling a byproduct of the step of reacting the fuel comprising carbon with the naturally occurring base in a single step.

7. The process of claim 6, wherein the recycling process only utilizes a single cation.

8. The process of claim 6, wherein the naturally occurring base is calcium hydroxide.

9. The process of claim 6, wherein the recycling process does not include a metathesis reaction step.

10. The process of claim 6, wherein the recycling step is a thermal decomposition step.

11. A process for producing hydrogen gas including the step of:
reacting a fuel component with a reaction mixture in the presence of a dissolution control agent to produce hydrogen gas,
said fuel component comprising carbon,
said reaction mixture comprising a solvent and a reaction component, the reaction component having a non solvated component and a solvated component, the non solvated component being in equilibrium with the solvated component.

12. The process of claim 11, wherein the dissolution control agent comprises at least one agent selected from the group consisting of a dissolution rate control agent and a solubility level control agent.

13. The process of claim 11, wherein the dissolution control agent comprises a non solvated component having a controlled surface area.

14. The process of claim 13, wherein the non solvated component has an average particle size of less than 20 microns.

15. The process of claim 13, wherein in the non solvated component comprises Ca(OH)₂.

16. The process of claim 11, wherein the non solvated component has an average particle size of about 0.5 microns to about 10 microns.

17. The process of claim 11, wherein the non solvated component has an average particle size of less than about 300 nanometers.

18. The process of claim 11, wherein the non solvated component has an average particle size of about 50 nanometers to about 260 nanometers.

19. The process of claim 11, wherein the non solvated component has a surface area greater than 0.1 m²/g.

20. The process of claim 11, wherein the non solvated component has a surface area between about 50 m²/g to about 300 m²/g.

21. The process of claim 11, wherein the dissolution control agent comprises an agent that chemically reacts to form the reaction component of the reaction mixture.

22. The process of claim 21, wherein the dissolution control agent comprises an alkali metal salt or an alkaline earth metal salt.

23. The process of claim 21, wherein the dissolution control agent comprises CaF₂ or CaCl₂.

24. The process of claim 11, wherein the dissolution control agent comprises an agitation process.

25. The process of claim 24, wherein the agitation process is a stirring process, a vibrating process, a vortexing process, or a milling process.

26. The process of claim 24, wherein the agitation agent is an ultrasonic agitation process.

27. The process of claim 24, wherein the agitation processes increases the dissolution rate of the nonsolvated component by a factor of greater than 100.

28. The process of claim 11, wherein the dissolution control agent is electromagnetic radiation.

29. The process of claim 11, wherein the electromagnetic radiation is microwave radiation.

30. The process of claim 11, wherein the dissolution control agent is thermal energy.

31. The process of claim 30, wherein the reaction mixture is heated to a temperature of above 100 Celsius.

32. The process of claim 30, wherein the thermal energy increases the solubility level of the reaction component by a factor of greater than 10 over the solubility level of the reaction component at 25 degrees Celsius.

33. The process of claim 11, wherein the dissolution control agent is a non aqueous solvent.

34. The process of claim 33, wherein the reaction mixture solvent comprises the non aqueous solvent and a second solvent.

35. The process of claim 33, wherein the reaction mixture solvent comprises a third solvent, said third solvent having a polarity level between the non aqueous solvent and the second solvent.

36. The process of claim 33, wherein the non aqueous solvent comprises an alcohol.

37. The process of claim 33, wherein the dissolution control agent is a surfactant.

38. The process of claim 11, wherein the dissolution control agent is a thickener.

39. The process of claim 38, wherein the viscosity of the reaction control mixture is between 5×10⁻³ Pa·s and 50×10⁻³ Pa·s.

40. The process of claim 38, wherein the surfactant thickener is a cellulose based thickener.

41. The process of claim 11, further including the step of:
thermally decomposing a metal carbonate precipitate to produce a metal oxide,
wherein said metal carbonate precipitate is formed during the process for producing hydrogen gas.

42. The process of claim 41, wherein said metal carbonate precipitate is calcium carbonate.

43. The process of claim 41, further comprising reacting said metal oxide with water to produce a metal hydroxide, wherein said metal oxide forms the solvated component and the non solvated component of the reaction mixture.

44. The process of claim 41, wherein the process does not include a carbonate metathesis reaction step.

45. The process of claim 11, wherein the non solvated component comprises at least one component selected from the group consisting of CaO and Ca(OH)₂.

46. The process of claim 1, wherein the wherein the non solvated component comprises at least one component selected from the group comprising Li₂O and LiOH.

47. The process of claim 1, wherein the reaction component comprises at least 15 weight % of the reaction mixture.

48. The process of claim 11, wherein the reaction component has a Ksp in the solvent of 6.5×10⁻⁶ or less at 25 degrees Celsius.

49. The process of claim 11, wherein the reaction mixture has a pH of 12.5 or less.

50. The process of claim 11, wherein the reaction mixture is maintained at a pH of between 10.5 and 14 during the hydrogen producing reaction.

51. The process of claim 11, wherein the dissolution control agent increases the dissolution rate of the non solvated component by a factor of 100 to a factor of 1,000.

52. The process of claim 11, wherein the dissolution control agent increases the dissolution rate of the non solvated component by a factor greater than 1,000.

53. The process of claim 11, wherein the dissolution control agent increases the solubility level of the non solvated component by a factor greater than 10.

54. The process of claim 11, wherein the dissolution control agent increases the solubility level of the non solvated component by a factor greater than 100.

55. The process of claim 11, wherein the dissolution control agent forms a colloidal suspension in the reaction mixture.
